(19) United States
(12) Patent Application Publication
(10) Pub. No.: US 2022/0212150 A1
(43) Pub. Date: Jul. 7, 2022

(54) Environmental friendly and energy-saving manufacturing device for amino acid coordination complexes

(71) Applicants: Lu TIAN, Heilongjiang (CN); Zhigang DENG, Shanghai (CN); Jiaping XU, Anhui (CN)

(72) Inventors: Lu TIAN, Heilongjiang (CN); Zhigang DENG, Shanghai (CN); Jiaping XU, Anhui (CN)

(21) Appl. No.: 17/142,259

(22) Filed: Jan. 6, 2021

(51) Int. Cl. B01F 7/18; A23N 17/00; B01F 7/00

(52) U.S. Cl. CPC B01F 7/18; A23N 17/001; A23K 20/142; B01F 7/0025; B01F 7/00641; A23N 17/007

(57) ABSTRACT

An manufacturing device for amino acid coordination complexes, containing a reaction mechanism including a paddle drying reaction kettle, a motor, a rotation shaft, and paddles; a wet-type dust collector; a vacuum pump, and an ozone generator; one end of the rotation shaft is connected to the motor; another end of the rotation shaft extends into the paddle drying reaction kettle; a plurality of paddles are disposed on an outer wall of the rotation shaft and are rotatable along with the rotation shaft; the paddle drying reaction kettle is connected to one end of a vacuum pump through a gas discharging pipe; another end of the vacuum pump is connected with the ozone generator; a middle part of the gas discharging pipe is connected with the wet-type dust collector; the wet-type dust collector has a first wet filter tank and a second filter tank.

### BACKGROUND OF THE INVENTION

The present invention relates to the technical field of manufacturing devices for amino acid coordination complexes, and more specifically relates to an environmental friendly and energy-saving manufacturing device for amino acid coordination complexes.

Coordination complexes of amino acids and trace elements are also called amino acid chelate salts, which play a major role in animal nutrition, and which are obtained through controlled complexation reaction of synthetic amino acids (such as methionine, lysine) being the raw material with copper, iron, zinc, manganese and cobalt etc. in an aqueous solution, or obtained from a raw material being amino acids produced by hydrolyzed animal and plant proteins.

The raw materials for the production of amino acid coordination complexes are generally based on amino acid residues and inorganic salts. During complexation reaction, odorous gases such as ammonia are generated, and these odorous gases may easily pollute the environment. Also, during the entire production process of amino acid coordination complexes, a larger number of devices which occupy lots of spaces are used, further, the required drying temperature is high and hence the energy consumption is high.

### BRIEF SUMMARY OF THE INVENTION

In view of the aforesaid disadvantages now present in the prior art, the present invention provides an environmental friendly and energy-saving manufacturing device for amino acid coordination complexes. The present invention solves the existing problem of large spaces occupied by the existing devices, reduces energy consumption, and treats waste gases timely to prevent environmental pollution.

To attain the above objects, the present invention provides the following technical solutions:

An environmental friendly and energy-saving manufacturing device for amino acid coordination complexes, comprising a reaction mechanism, a wet-type dust collector, a vacuum pump, and an ozone generator; the reaction mechanism comprises a paddle drying reaction kettle, a motor, a rotation shaft, paddles, a first supporting rack and a second supporting rack; the motor is mounted to an upper side of the first supporting rack; the paddle drying reaction kettle is mounted to an upper side of the second supporting rack; a rear end of the paddle drying reaction kettle is provided with a bearing;

one end of the rotation shaft is connected to the motor; another end of the rotation shaft passes through the bearing and extends into the paddle drying reaction kettle; a plurality of paddles are disposed on an outer wall of the rotation shaft; the paddles are arranged in an array along an axial direction of the rotation shaft and are rotatable along with the rotation shaft;

an upper side of the paddle drying reaction kettle is provided with a material feeding opening; a front end of the paddle drying reaction kettle is provided with a material outlet opening;

the upper side of the paddle drying reaction kettle is also provided with a heat energy inlet; a lower side of the paddle drying reaction kettle is provided with a heat energy outlet;

the upper side of the paddle drying reaction kettle is also provided with a vacuum port; one end of a gas discharging pipe is connected to the vacuum port;

a middle part of the gas discharging pipe is connected with the wet-type dust collector; the wet-type dust collector comprises a first wet filter tank and a second filter tank; the first wet filter tank and the second filter tank are sequentially arranged along a lengthwise direction of the gas discharging pipe; a condensate water outlet opening is provided at a bottom part of the second filter tank;

another end of the gas discharging pipe is connected with the vacuum pump; an end of the vacuum pump opposite to an end of which connecting to the gas discharging pipe is connected with the ozone generator; an end of one side of the ozone generator is provided with a chimney.

Preferably, a material feeding funnel is provided on the material feeding opening, and a first protective cover is further mounted on an upper side of the material feeding funnel.

Preferably, one end of each paddle is provided with a stirring plate; an included angle of 45 degrees is formed between the stirring plate and a distance between a free end of the stirring plate and an axis of the rotation shaft.

Preferably, an outer side wall of the paddle drying reaction kettle is provided with a first observation transparent window; the first observation transparent window has a rectangular shape; the first observation transparent window is provided longitudinally across an entire length of the paddle drying reaction kettle.

Preferably, a second protective cover is provided on each of the heat energy inlet and the heat energy outlet.

Preferably, an outer wall of the first wet filter tank is provided with a second observation transparent window made of transparent material.

Preferably, a circulation pipe is provided with one end connected to the first wet filter tank and another end connected to the paddle drying reaction kettle; an electronic valve is provided on the circulation pipe.

Preferably, a control panel is provided on an outer wall of the first wet filter tank; an electronic liquid level meter is provided inside the first wet filter tank; the control panel is connected in series with the electronic liquid level meter and the electronic valve.

By means of the above technical solutions, the present invention has the following beneficial advantages:

The present invention provides an environmental friendly and energy-saving manufacturing device for amino acid coordination complexes, comprising a reaction mechanism, a wet-type dust collector, a vacuum pump, and an ozone generator; the reaction mechanism comprises a paddle drying reaction kettle, a motor, a rotation shaft, paddles, a first supporting rack and a second supporting rack; one end of the rotation shaft is connected to the motor; another end of the rotation shaft passes through a bearing and extends into the paddle drying reaction kettle; a plurality of paddles are disposed on an outer wall of the rotation shaft; an upper side of the paddle drying reaction kettle is provided with a material feeding opening; a front end of the paddle drying reaction kettle is provided with a material outlet opening; the upper side of the paddle drying reaction kettle is also provided with a heat energy inlet; a lower side of the paddle drying reaction kettle is provided with a heat energy outlet; the upper side of the paddle drying reaction kettle is also provided with a vacuum port; one end of a gas discharging pipe is connected to the vacuum port; a middle part of the gas discharging pipe is connected with the wet-type dust collector; the wet-type dust collector comprises a first wet filter tank and a second filter tank; another end of the gas discharging pipe is connected with the vacuum pump; an end of the vacuum pump opposite to an end of which connecting to the gas discharging pipe is connected with the ozone generator; an end of one side of the ozone generator is provided with a chimney. Due to the above configurations, the present invention provides a simple structure that solves the existing problem of large spaces occupied by the existing devices, reduces energy consumption, and treats waste gases timely to prevent environmental pollution.

In the present invention, a material feeding funnel is provided on the material feeding opening, and a first protective cover is further mounted on an upper side of the material feeding funnel. Due to the above configurations, material can be conveniently fed in, and waste of material can be prevented.

In the present invention, one end of each paddle is provided with a stirring plate; an included angle of 45 degrees is formed between the stirring plate and a distance between a free end of the stirring plate and an axis of the rotation shaft. Due to the above configurations, reaction effect is strengthened to facilitate production.

In the present invention, an outer side wall of the paddle drying reaction kettle is provided with a first observation transparent window; the first observation transparent window has a rectangular shape. Due to the above configurations, the entire drying and reaction process can be conveniently observed.

In the present invention, a second protective cover is provided on each of the heat energy inlet and the heat energy outlet. Due to the above configurations, the impurities that may affect product quality are prevented from getting inside the paddle drying reaction kettle.

In the present invention, an outer wall of the first wet filter tank is provided with a second observation transparent window made of transparent material. Due to the above configurations, the water level inside the first wet filter tank can be conveniently observed.

In the present invention, a circulation pipe is provided with one end connected to the first wet filter tank; an electronic valve is provided on the circulation pipe. Due to the above configurations, when water evaporated from the paddle drying reaction kettle containing a small amount of ammonia enters the first wet filter tank via the gas discharging pipe until water in the first wet filter tank containing collected dust and absorbed ammonia reaches a pre-determined level, the water containing collected dust and absorbed ammonia from the first wet filter tank is then transferred back again to the paddle drying reaction kettle via the circulation pipe.

In the present invention, a control panel is provided on an outer wall of the first wet filter tank; an electronic liquid level meter is provided inside the first wet filter tank. Due to the above configurations, timely alert and control can be achieved to prevent the water level from becoming too high.

In summary, the present invention provides an environmental friendly and energy-saving manufacturing device for amino acid coordination complexes. The present invention has a simple structure and is easy to operate. The present invention solves the existing problem of large spaces occupied by the existing devices, reduces energy consumption, and treats waste gases timely to prevent environmental pollution, thereby being suitable to be promoted for use.

### BRIEF DESCRIPTION OF THE DRAWINGS

In order to describe the technical solutions provided by the embodiments of the present invention or the prior arts more clearly, the figures required in the description of the embodiments below or in the description of the prior arts will be briefly introduced below. Throughout the figures, the same or similar elements or parts are generally referred to in the figures by the same or similar reference numbers. The elements or parts illustrated in the figures may not be necessarily drawn according to actual scales.

FIG. 1 is a schematic structural view of the environmental friendly and energy-saving manufacturing device for amino acid coordination complexes according to the present invention.

FIG. 2 is a schematic structural view of the paddle drying reaction kettle of the present invention.

Reference numbers in the figures: 1—reaction mechanism; 11—paddle drying reaction kettle; 111—material feeding opening; 112; material outlet opening; 113—heat energy inlet; 114—heat energy outlet; 115—vacuum port; 116—first observation transparent window; 117—second protective cover; 12—motor; 13—rotation shaft; 14—paddles; 141—stirring plate; 15—first supporting rack; 16—second supporting rack; 17—bearing; 18—gas discharging pipe; 2—wet-type dust collector; 21—first wet filter tank; 211—second observation transparent window; 212—electronic liquid level meter; 22—second filter tank; 221—condensate water outlet opening; 23—circulation pipe; 231—electronic valve; 3—vacuum pump; 4—ozone generator; 41—chimney; 5—material feeding funnel; 51—first protective cover; 6—control panel.

### DETAILED DESCRIPTION OF THE INVENTION

The technical solutions provided by the present invention will be further described in detail below with reference to an embodiment. The embodiment given below is intended for the purpose of illustration only in order to explain the technical solutions provided by the present invention more clearly. The given embodiment should not limit the scope of protection of the present invention.

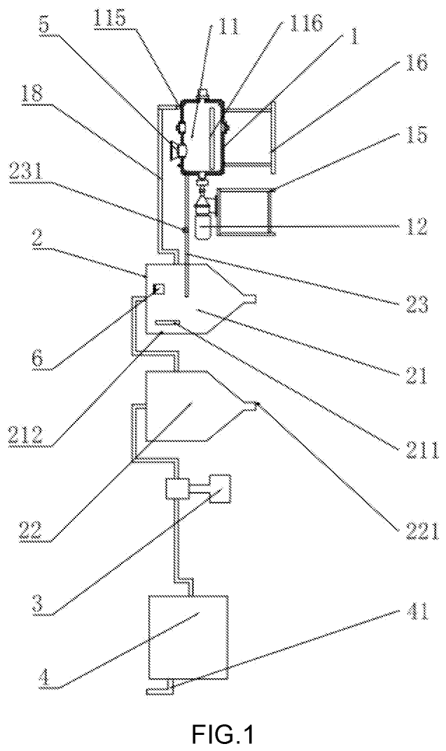

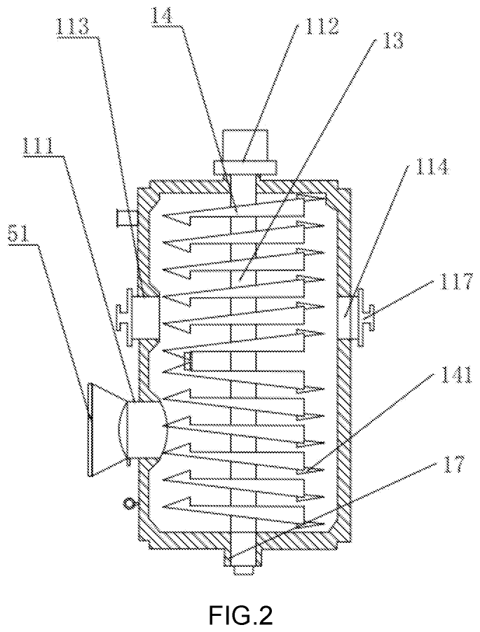

FIGS. 1-2 illustrate an environmental friendly and energy-saving manufacturing device for amino acid coordination complexes according to the present invention, comprising a reaction mechanism 1, a wet-type dust collector 2, a vacuum pump 3, and an ozone generator 4; the reaction mechanism 1 comprises a paddle drying reaction kettle 11, a motor 12, a rotation shaft 13, paddles 14, a first supporting rack 15 and a second supporting rack 16; the motor 12 is mounted to an upper side of the first supporting rack 15; the paddle drying reaction kettle 11 is mounted to an upper side of the second supporting rack 16; a rear end of the paddle drying reaction kettle 11 is provided with a bearing 17; the first supporting rack 15 supports the motor 12, and the second supporting rack 16 supports the paddle drying reaction kettle 11.

One end of the rotation shaft 13 is connected to the motor 12; another end of the rotation shaft 13 passes through the bearing 17 and extends into the paddle drying reaction kettle 11.

A plurality of paddles 14 are disposed on an outer wall of the rotation shaft 13; the paddles 14 are arranged in an array along an axial direction of the rotation shaft and are rotatable along with the rotation shaft 13. During the reaction process of amino acid residues and inorganic salts, the paddles 14 ensure good reaction effect.

One end of each paddle 14 is provided with a stirring plate 141; an included angle of 45 degrees is formed between the stirring plate and a distance between a free end of the stirring plate and an axis of the rotation shaft to strengthen the reaction effect and hence facilitating production.

An upper side of the paddle drying reaction kettle 11 is provided with a material feeding opening 111; a material feeding funnel 5 is provided on the material feeding opening 111, and a first protective cover is further mounted on an upper side of the material feeding funnel 5 to facilitate material feeding and present the waste of raw material.

A front end of the paddle drying reaction kettle 11 is provided with a material outlet opening 112; by rotating the paddles 14 towards a same direction, residues inside including those at a bottom part of the paddle drying reaction kettle 11 can be discharged through the material outlet opening 112.

An outer side wall of the paddle drying reaction kettle 11 is provided with a first observation transparent window 116; the first observation transparent window 116 has a rectangular shape; the first observation transparent window 116 is provided longitudinally across an entire length of the paddle drying reaction kettle 11 so that the entire drying and reaction processes inside the paddle drying reaction kettle can be observed.

The upper side of the paddle drying reaction kettle 11 is also provided with a heat energy inlet 113; a lower side of the paddle drying reaction kettle 11 is provided with a heat energy outlet 114; during the drying process, the heat energy inlet 113 is connected with a heat source; the heat energy outlet 114 is an exit for the heat energy. The heat energy inlet 113 and the heat energy outlet 114 facilitate the drying process.

A second protective cover 117 is provided on each of the heat energy inlet 113 and the heat energy outlet 114 in order to prevent impurities that may affect product quality from getting inside the paddle drying reaction kettle 11 when the paddle drying reaction kettle 11 is not in use.

The upper side of the paddle drying reaction kettle 11 is also provided with a vacuum port 115; one end of a gas discharging pipe 18 is connected to the vacuum port 115.

Another end of the gas discharging pipe 18 is connected with the vacuum pump 3. By using the vacuum pump 3, the paddle drying reaction kettle 11 under a drying function mode will have negative pressure so that the boiling point of water is reduced, and hence drying and evaporation can be performed under a relatively lower temperature. Drying under a reduced temperature can save energy and protect some metal elements which are more active in terms of chemical valency, such as iron.

A middle part of the gas discharging pipe 18 is connected with the wet-type dust collector 2; the wet-type dust collector 2 comprises a first wet filter tank 21 and a second filter tank 22.

The first wet filter tank 21 and the second filter tank 22 are sequentially arranged along a lengthwise direction of the gas discharging pipe 18; a condensate water outlet opening 221 is provided at a bottom part of the second filter tank 22; 50% of a volume of the first wet filter tank 21 is initially filled with water; the second filter tank 22 is an empty tank.

As said, 50% of the volume of the first wet filter tank 21 is initially filled with water to collect dust and to absorb a small amount of ammonia; during operation, water evaporated from the paddle drying reaction kettle 11 containing a small amount of ammonia also enters the first wet filter tank 21 via the gas discharging pipe 18; when level of water containing collected dust and absorbed ammonia inside the first wet filter tank 21 has reached a pre-determined position, the water from the first wet filter tank containing collected dust and absorbed ammonia is transferred back again into the paddle drying reaction kettle 11; part of water vapor resulted after filtration in the first wet filter tank 21 is brought to the second filter tank 22 and condensed into condensate water in the second filter tank 22, and the condensate water is discharged through the condensate water outlet opening 221 so that water will not enter the ozone generator 4.

An outer wall of the first wet filter tank 21 is provided with a second observation transparent window 211 made of transparent material. Through the second observation transparent window, water level inside the first wet filter tank 21 can be conveniently observed.

A circulation pipe 23 is provided with one end connected to the first wet filter tank 21 and another end connected to the paddle drying reaction kettle 11; an electronic valve 231 is provided on the circulation pipe 23; when the level of water containing collected dust and absorbed ammonia inside the first wet filter tank has reached the pre-determined position, the electronic valve is activated to open so as to allow the water from the first wet filter tank containing collected dust and absorbed ammonia to transfer back again into the paddle drying reaction kettle via the circulation pipe.

A control panel 6 is provided on an outer wall of the first wet filter tank 21; an electronic liquid level meter 212 is provided inside the first wet filter tank 21; the control panel 6 is connected in series with the electronic liquid level meter 212 and the electronic valve 231 for timely alert and control to prevent water level from becoming too high; specifically, when the electronic liquid level meter 212 detects that the water level has reached the pre-determined position, the control panel 6 is activated to open the electronic valve 231 so as to allow the water containing collected dust and absorbed ammonia from the first wet filter tank 21 to transfer back again into the paddle drying reaction kettle 11 via the circulation pipe.

An end of the vacuum pump 3 opposite to an end of which connecting to the gas discharging pipe 18 is connected with the ozone generator 4; an end of one side of the ozone generator 4 is provided with a chimney 41; the ozone generator 4 achieves oxidoreduction of ammonia produced throughout the entire production process, wherein the oxidoreduction reaction is as follows: NH₃+O₃=N₂+O₂+H₂O; therefore, ammonia, when reacted with ozone, is transformed into non-toxic gases which are colorless and odorless, and these non-toxic gases are discharged through the chimney 41 high up into the air.

It should be understood that, the embodiments described above are only intended to explain the technical solutions given by the present invention. The embodiments described herein should not limit the present invention. Although the present invention is described in detail above with reference to the embodiments, a person skilled in this field of art should understand that changes to the technical solutions disclosed by the described embodiments can be made, or parts or all of the technical features described in the embodiments can be replaced by other equivalents achieving the same technical effects. As long as the essence of the technical solutions enabled by these changes or replacements is not deviated from the scope of the technical solutions disclosed by the embodiments, these changes or replacements should fall within the scope defined by the description and the claims of the present invention.

What is claimed is:

1. An manufacturing device for amino acid coordination complexes, comprising a reaction mechanism, a wet-type dust collector, a vacuum pump, and an ozone generator; the reaction mechanism comprises a paddle drying reaction kettle, a motor, a rotation shaft, paddles, a first supporting rack and a second supporting rack; the motor is mounted to an upper side of the first supporting rack; the paddle drying reaction kettle is mounted to an upper side of the second supporting rack; a rear end of the paddle drying reaction kettle is provided with a bearing;
one end of the rotation shaft is connected to the motor; another end of the rotation shaft passes through the bearing and extends into the paddle drying reaction kettle; a plurality of paddles are disposed on an outer wall of the rotation shaft; the paddles are arranged in an array along an axial direction of the rotation shaft and are rotatable along with the rotation shaft;
an upper side of the paddle drying reaction kettle is provided with a material feeding opening; a front end of the paddle drying reaction kettle is provided with a material outlet opening;
the upper side of the paddle drying reaction kettle is also provided with a heat energy inlet; a lower side of the paddle drying reaction kettle is provided with a heat energy outlet;
the upper side of the paddle drying reaction kettle is also provided with a vacuum port; one end of a gas discharging pipe is connected to the vacuum port; a middle part of the gas discharging pipe is connected with the wet-type dust collector; the wet-type dust collector comprises a first wet filter tank and a second filter tank; the first wet filter tank and the second filter tank are sequentially arranged along a lengthwise direction of the gas discharging pipe;
a condensate water outlet opening is provided at a bottom part of the second filter tank;
another end of the gas discharging pipe is connected with the vacuum pump;
an end of the vacuum pump opposite to an end of which connecting to the gas discharging pipe is connected with the ozone generator; an end of one side of the ozone generator is provided with a chimney.

2. The manufacturing device for amino acid coordination complexes according to claim 1, wherein a material feeding funnel is provided on the material feeding opening, and a first protective cover is further mounted on an upper side of the material feeding funnel.

3. The manufacturing device for amino acid coordination complexes according to claim 1, wherein one end of each paddle is provided with a stirring plate; an included angle of 45 degrees is formed between the stirring plate and a distance between a free end of the stirring plate and an axis of the rotation shaft.

4. The manufacturing device for amino acid coordination complexes according to claim 1, wherein an outer side wall of the paddle drying reaction kettle is provided with a first observation transparent window; the first observation transparent window has a rectangular shape; the first observation transparent window is provided longitudinally across an entire length of the paddle drying reaction kettle.

5. The manufacturing device for amino acid coordination complexes according to claim 1, wherein a second protective cover is provided on each of the heat energy inlet and the heat energy outlet.

6. The manufacturing device for amino acid coordination complexes according to claim 1, wherein an outer wall of the first wet filter tank is provided with a second observation transparent window made of transparent material.

7. The manufacturing device for amino acid coordination complexes according to claim 1, wherein a circulation pipe is provided with one end connected to the first wet filter tank and another end connected to the paddle drying reaction kettle; an electronic valve is provided on the circulation pipe.

8. The manufacturing device for amino acid coordination complexes according to claim 7, wherein a control panel is provided on an outer wall of the first wet filter tank; an electronic liquid level meter is provided inside the first wet filter tank; the control panel is connected in series with the electronic liquid level meter and the electronic valve; 50% of a volume of the first wet filter tank is initially filled with water; also, water evaporated from the paddle drying reaction kettle containing a small amount of ammonia enters the first wet filter tank via the gas discharging pipe; when the electronic liquid level meter detects that level of water containing collected dust and absorbed ammonia inside the first wet filter tank has reached a pre-determined position, the control panel is activated to open the electronic valve so as to allow the water from the first wet filter tank containing collected dust and absorbed ammonia to transfer back again into the paddle drying reaction kettle via the circulation pipe.
